(19) United States
(12) Patent Application Publication
(10) Pub. No.: US 2017/0312962 A1
(43) Pub. Date: Nov. 2, 2017

(54) METHOD AND APPARATUS FOR INJECTION MOULDING OF PLASTIC MATERIALS

(71) Applicant: INGLASS S.p.A., San Polo di Piave (Treviso) (IT)

(72) Inventor: Maurizio BAZZO, San Polo di Piave (Treviso) (IT)

(21) Appl. No.: 15/499,984

(22) Filed: Apr. 28, 2017

(30) Foreign Application Priority Data
May 2, 2016 (IT) 102016000044688

(51) Int. Cl. B29C 45/28; B29C 45/00; B29K 105/00

(52) U.S. Cl. CPC B29C 45/2803; B29C 45/0046; B29K 2105/0058

(57) ABSTRACT

Method and apparatus for injection moulding of plastic materials using at least one nozzle with an obturator including a stem having a through hole and displaceable transversely with respect to the nozzle between a closing position and an opening position wherein the through hole opens communication between the nozzle and the flow path towards the mould. When the obturator is arranged in the closing position following injection, the through hole remains in communication with the cavity of the mould and a residual core made of plastic material present in the through hole remains joined to a residual core made of plastic material in the flow path and it is removed together with it.

### FIELD OF THE INVENTION

The present invention regards a method and an apparatus for injection moulding of plastic materials of the type in which there is provided at least one nozzle for introducing the fluid plastic material under pressure into the cavity of a mould.

### STATE OF THE PRIOR ART

Moulding apparatus in which—in order to control the flow of molten plastic material flowing out from an injector—there are used obturation systems made up of a stem axially moveable in the nozzle of the injector between an advanced closing position and a receded opening position, are known in the art, for example from EP-2918389 on behalf of the Applicant.

Such stem is displaced by means of a fluid or electric actuator arranged upstream of the injector and fixed, for example, to the distributor of the plastic material to be injected, or in a recess of the fixing plate of the mould or directly to the machine platen.

The presence of the obturator in the nozzle reveals several drawbacks. Firstly, an accurate closure of the stem of the injector requires providing the system with a valve guide at the distributor to guarantee the aligning of the stem with the terminal of the nozzle and avoid seepage of material. The valve guide is often an element critical for the system, due to the strict tolerances required and frequent problems related to the stagnation of material therein.

Furthermore, the presence of the obturator in the nozzle negatively impacts the regularity of the flow of plastic material, with the risk of generating visible defects on the moulded piece in proximity of the terminal of the nozzle.

In order to overcome these drawbacks, an obturation system made up of a stem having a through hole and arranged outside the flow channel of the nozzle is known in the art. The stem can be displaced transversely with respect to the nozzle, between a closing position in which communication between the nozzle and the mould by means of the through hole is interrupted, and an opening position in which the through hole opens the communication between the nozzle and the mould.

An advantage of the embodiment with an external obturator lies in the fact that the force required to displace the stem is considerably low with respect to the one required for an obturator moveable in the nozzle. This is due to the fact that the friction for drawing the material on the stem of the obturator is absent. This enables providing the moulding system with less powerful and simultaneously more compact and economic actuators.

For example, the United States document U.S. Pat. No. 4,077,760 and the Japanese document JP-56089322 illustrate the mechanism for closing and opening a nozzle by means of the aforementioned lateral obturation system referred to as of the “slot” type. The system for actuating the obturator selectively displaces the stem in two positions. In a first position, the hole, whose diameter can be compared to that of the outflow of the material from the nozzle, is aligned with the terminal of the nozzle to enable the through flow of the molten plastic material into the mould. Once through with the injection, the stem is displaced in a second position for misaligning the hole of the stem with respect to the terminal of the nozzle and block the flow of the plastic material, so as to enable the opening of the mould and the removal of the moulded piece.

In the case illustrated by U.S. Pat. No. 4,077,760, the stem has, additionally to the hole with diameter comparable to that of the outlet of the nozzle, a second hole with smaller diameter that is used in the final steps of the moulding cycle to optimise the stacking of the plastic material in the mould. The closing position of the lateral obturator is intermediate between the two holes.

Both known devices reveal criticalities due to the residual core made of plastic material in the hole of the stem which, upon completing the injection, is dragged towards the closing position by the obturator and, upon cooling, it hardens sticking to the walls of the hole. At the subsequent moulding, the flow of plastic material coming from the nozzle will push the hardened material present in the hole of the obturator into the cavity of the mould, thus causing visible defects on the moulded piece.

In order to avoid this drawback, before the subsequent moulding cycle, this residual core must be manually removed from the hole of the obturator, for example by drilling, so as not to cause defects on the moulded piece in the subsequent step for injecting the molten plastic material into the mould. Such manual removal inevitably causes an increase of the time of each moulding cycle and requires dedicated operators and instruments.

The United States document U.S. Pat. No. 5,328,352 discloses an alternative method for removing such hardened residual core made of plastic material from the hole of the lateral obturator. Such method provides for, between two subsequent moulding cycles following the removal of the moulded piece, the displacement of the stem of the obturator in the opening position and the replacement of the nozzle with a pushing element suitable to eject the residual core present both in the hole and in the flow path from the nozzle to the mould.

This solution extremely complicates the structure of the system, the times for auxiliary operations remain high and such configuration is unsuitable for systems provided with a plurality of injectors, given that they have to provide for the ejection of every single material residue from every hole of each nozzle.

Document JP-56420110 describes a moulding apparatus of the type indicated above and addresses the technical problem of avoiding, at the end of the injection, the loss and hardening of plastic material in a first gate. The injection step occurs by means of an obturator moveable transversely with respect to the injector and having a through hole. When the mould is closed, the plastic material is injected through the first gate and a second gate placed in mutual communication by means of the through hole of the obturator, arranged in the opening position thereof. When the mould is opened, at the end of the injection, the opening displacement of the moveable part of the mould enables the obturator to translate to the closing position under the action of a spring, so as to misalign the through hole thereof with respect to the first gate, closing it so as to avoid the hardening of the plastic material therein. Thus, the displacement of the obturator from the position for opening to the position for closing the flow path occurs simultaneously with opening of the mould, and the through hole remains in communication with the second gate which has widened in the meanwhile. The residual core made of plastic material present in the second gate and the one present in the through hole cannot be removed together with the moulded article when removing the latter, given that upon opening the mould, the relative movement between the obturator and the fixed part of the mould and thus between the through hole and the first gate, causes a corresponding relative movement between the two residual cores present therein, with an ensuing mutual detachment upon cutting. The subsequent upward removal of the moulded article from the mould, causes the separation between the two residual cores.

### SUMMARY OF THE INVENTION

The object of the invention is to overcome the aforementioned drawbacks, and more in particular to provide a moulding method and apparatus of the type described above, configured so as to enable the removal of the residual core made of plastic material, present in the hole of the obturator at the end of each injection cycle, in a simple, quick and efficient manner.

According to the invention this object is attained thanks to a method according to the pre-characterising part of claim 1, whose distinctive characteristic lies in the fact that when the obturator is arranged in the closing position following the injection, the through hole remains in communication with the cavity of the mould and the second residual core made of plastic material present in said through hole of the obturator remains joined to the first residual core made of plastic material present in the flow path and it is removed together with it.

Thanks to this solution idea, the formation of the residual cores made of plastic material in the hole of the stem of the obturator are automatically removed at the end of every moulding cycle, thus overcoming the need for manual interventions or auxiliary devices between one moulding cycle and the subsequent one.

In a first embodiment of the invention, the through hole communicates with the flow path even in the closing position of the obturator, thus the second residual core made of plastic material present in the hole of the stem is directly joined with the first residual core formed in the flow path, and both residual cores are removed as a single block when removing the moulded article.

In a second embodiment of the invention, arranged adjacent to the flow path is a recess communicating with the cavity of the mould and, in the closing position of the obturator, with the through hole of the stem. In such recess, the injected plastic material forms a third residual core, thus the second residual core present in the through hole of the stem of the obturator is indirectly joined to the first residual core through the third residual core and it is removed together with it when removing the moulded article.

The injection moulding apparatus for implementing the method according to the invention is defined, in its broadest sense, in claim 4.

### BRIEF DESCRIPTION OF THE DRAWINGS

The invention will now be described in detail, purely by way of non-limiting example, with reference to the attached drawings, wherein:

FIG. 1 is a vertical section schematic view of an injection moulding apparatus provided with two nozzles with lateral obturators respectively according to a first and a second embodiment of the invention,

FIGS. 2 to 5 are partial views—in larger scale—of the nozzle obturation system according to the first embodiment of FIG. 1, represented in four different subsequent operative positions,

FIGS. 6 to 9 are partial views—in larger scale—of the nozzle obturation system according to the second embodiment of FIG. 1, represented in four different subsequent operative positions.

### DETAILED DESCRIPTION OF THE INVENTION

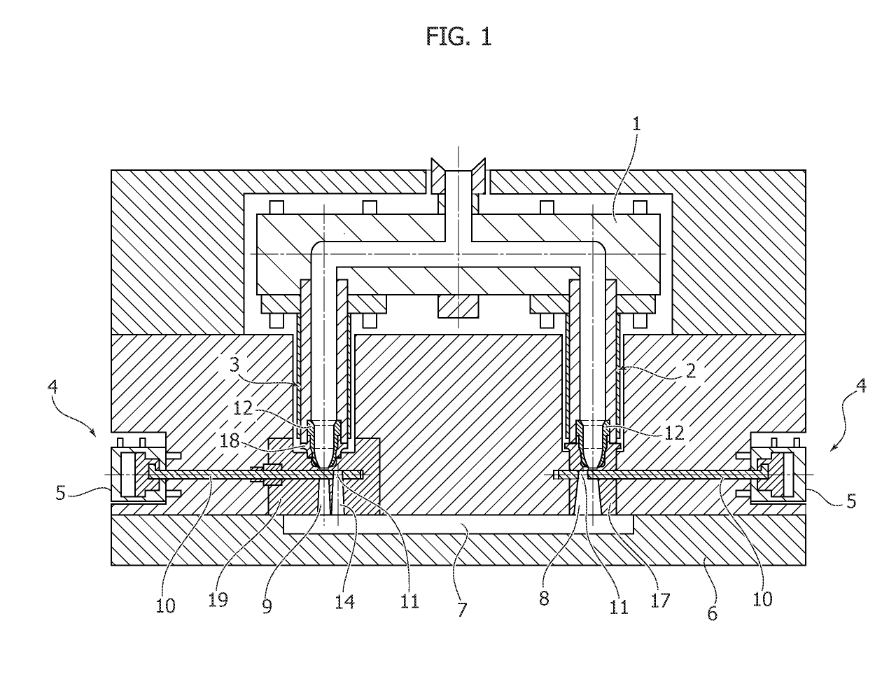

Initially with reference to FIG. 1, a plastic material injection moulding apparatus conventionally comprises a hot chamber 1 to which the plastic material to be injected in fluid state is supplied under pressure through nozzles 2, 3 in the case of the illustrated example with respective lateral obturators 4 controlled through fluid or electric actuators 5. In a conventional manner, the terminal of each nozzle 2, 3 comprises a tubular tip 12 in communication with the hot chamber 1.

Each obturator 4 comprises a stem 10 provided with a through hole 11 and it cooperates with the respective nozzle 2, 3 to open or close the flow of the fluid plastic material under pressure towards a mould 6 through a respective flow path 8, 9 in communication with the cavity 7 of the mould 6. Both the inner surface of the through hole 11 and that of the flow path 8, 9 are slightly frusto-conical-shaped, diverging towards the cavity 7 of the mould 6.

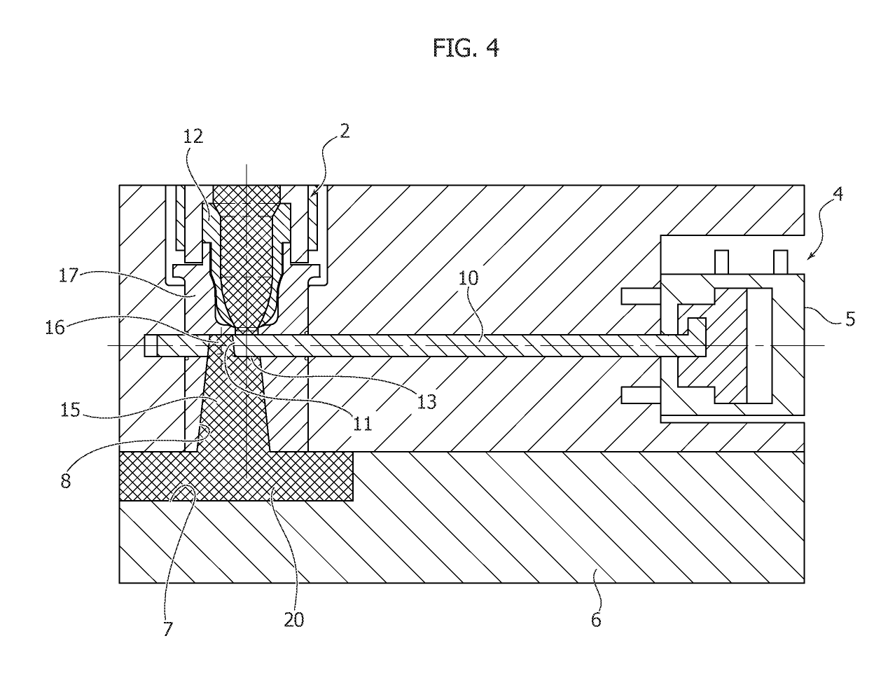

According to the first embodiment, illustrated on the right side of FIG. 1, the flow path 8 between the nozzle 2 and the cavity 7 of the mould 6 has an inlet section 13 having a width preferably at least twice the width of the through hole 11 so that, even in the closing position of the lateral obturator 4, represented in FIG. 1 and in larger detail in FIG. 4, the through hole 11 remains in communication with the flow path 8 and thus with the cavity 7 of the mould 6.

Associated to the tip 12 of the nozzle 2 is a ring nut 17 which extends up to the cavity 7 of the mould 6 forming the flow path 8, and the stem 10 of the obturator 4 traverses the ring nut 17 closely adjacent to the tip 12, transversely to the axis of the nozzle 2.

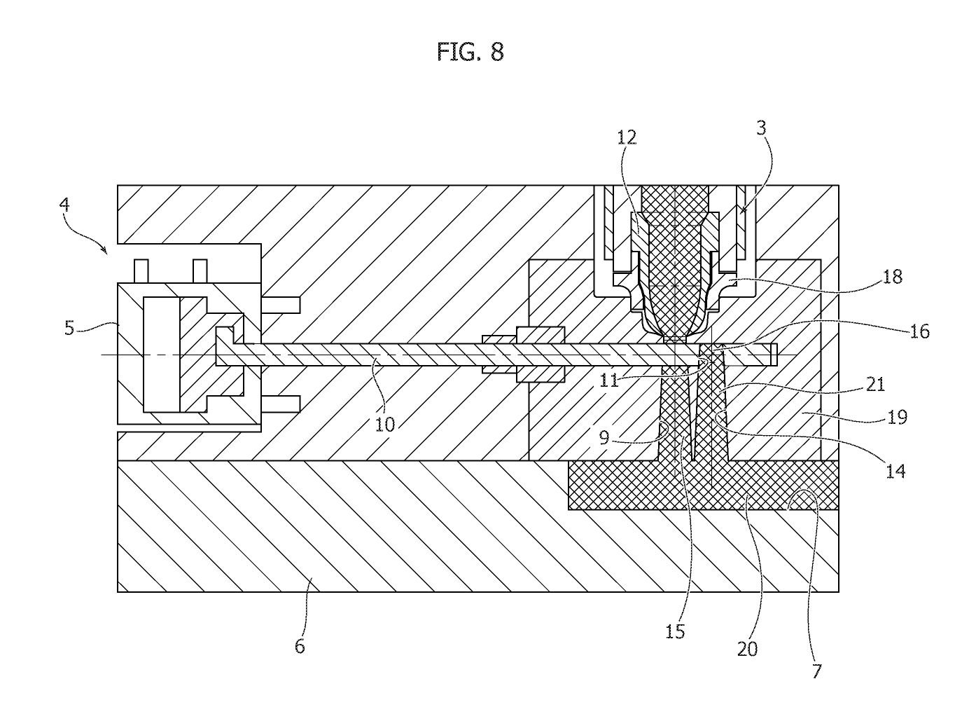

In the second embodiment represented in the left side of FIG. 1, arranged adjacent to the flow path 9, which is smaller in size with respect to flow path 8, is a recess 14 having an inner frusto-conical surface diverging towards the cavity 7 of the mould 6. The recess 14, which for example is substantially of the same size as the flow path 9, communicates with the cavity 7 of the mould 6 on the one side and with the through hole 11 of the stem 10 of the nozzle 3 on the other side in the closing position of the obturator 4, represented in FIG. 1 and more in detail in FIG. 8.

Associated to the tip 12 of the nozzle 3 is a ring nut 18 spaced from the cavity 7 of the mould 6, and provided between the tip 12 and the mould 6 is an insert 19 in which the flow path 9 and the recess 14 are formed. The stem 10 slidably extends, transversely to the axis of the nozzle 3, in the insert 19.

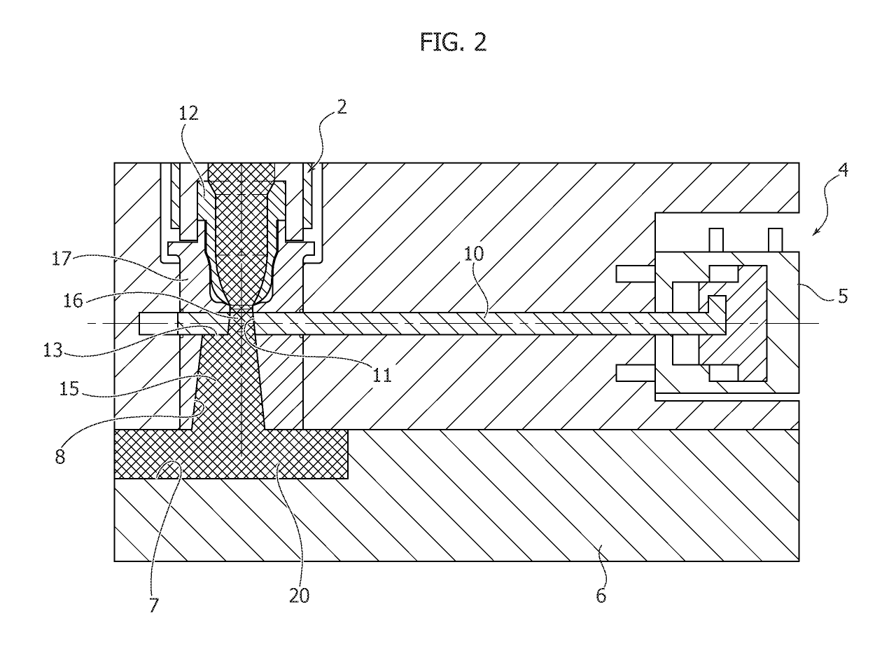

FIG. 2 shows an enlargement of the right part of FIG. 1, i.e. the first embodiment of the invention, in which the obturator 4 of the nozzle 2 is in the opening position. The through hole 11 of the stem 10 is aligned with the tip 12 of the nozzle 2, thus enabling the through flow of plastic material from the nozzle 2 to the cavity 7 of the mould 6 through the flow path 8.

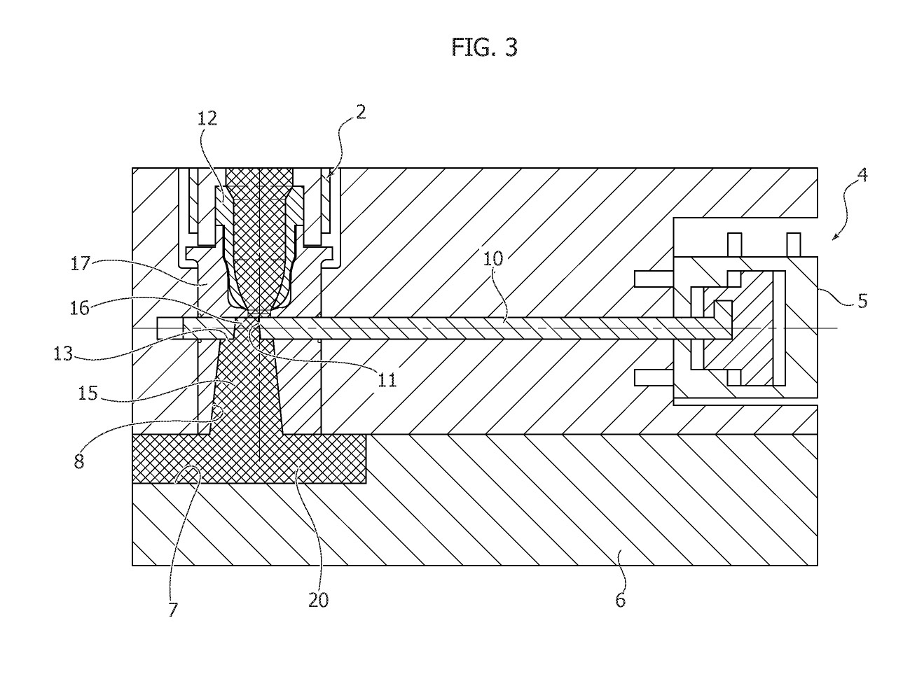

In FIG. 3 the obturator 4 is shown in an intermediate position for the semi-closure of the flow of plastic material, while in FIG. 4 the obturator 4 is represented in the complete closing configuration. In this closing configuration, required for opening the mould and removing the moulded piece, the injected plastic material is cooled forming a first residual core 15 in the flow path 8 and a second residual core 16 in the through hole 11 of the stem 10.

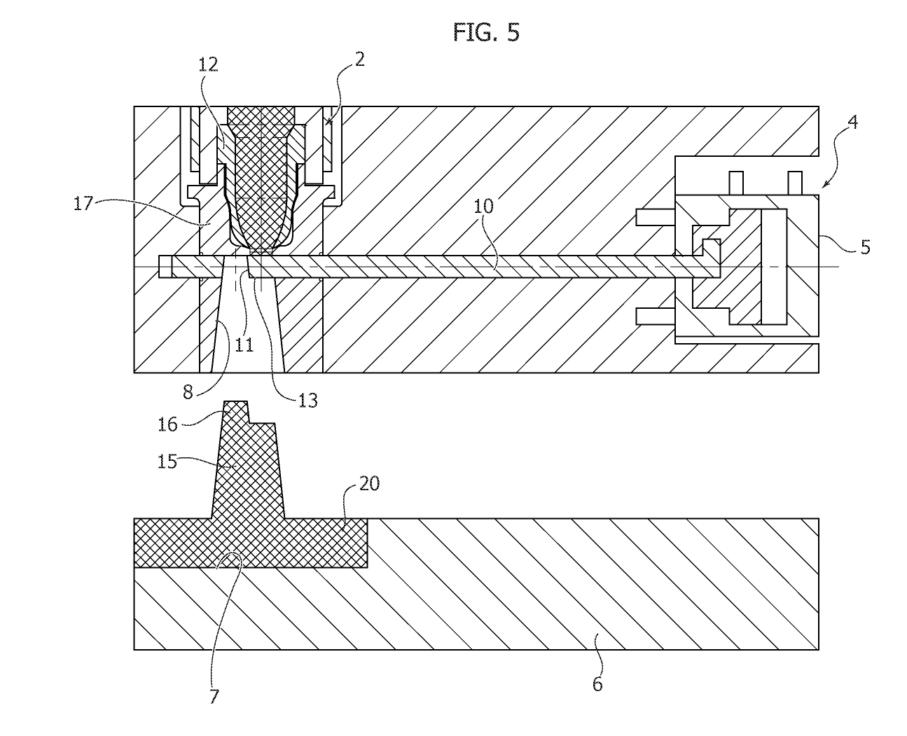

As clearly visible in FIG. 4, the first and the second residual cores 15, 16 are placed in direct mutual contact through the inlet section 13 and during the cooling thereof, they mutually join forming a single residual core which is in turn joined—at the lower part thereof—to the material of the moulded piece 20, as represented in FIG. 5. Thus, the second residual core 16 remains joined to the first residual core 15 and it is removed together with it when the mould is opened and the moulded article is removed.

The joining between the first and the second residual core 15, 16 is facilitated by the residual pressure of the material of the moulded piece 20 in the cavity 7 of the mould 6, following the closing of the flow path 8. The pressure pushes the first residual core 15 against the second residual core 16, facilitating the joining thereof.

In addition, the slightly frusto-conical shape of the residual cores 15, 16 conferred by the shape of the flow path 8 and the through hole 11 respectively, facilitates the removal thereof even due to the reduction of volume due to the cooling.

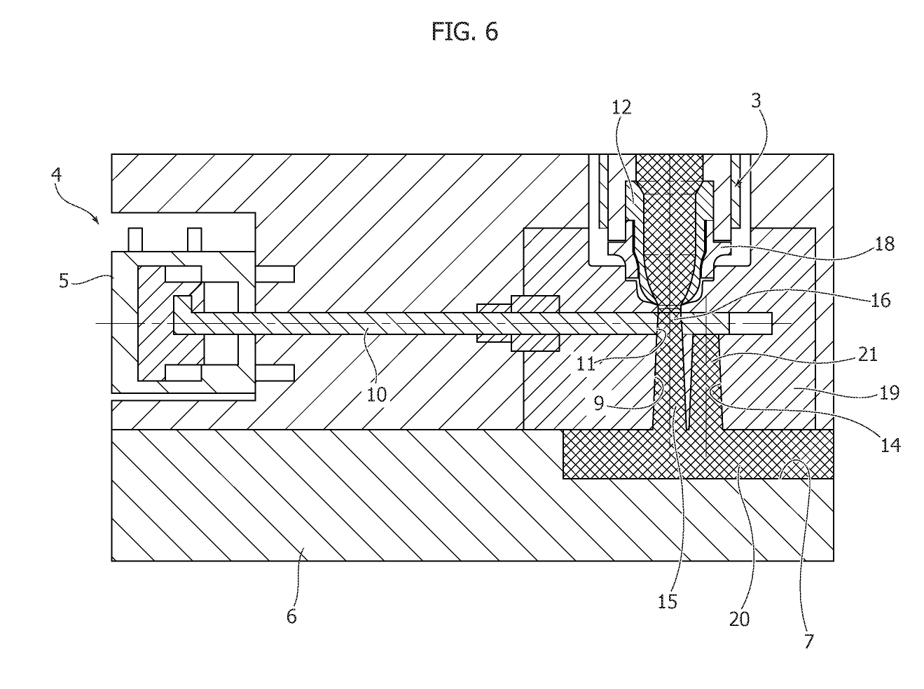

FIG. 6 shows an enlargement of the left part of FIG. 1, i.e. the second embodiment of the invention, in which the obturator 4 of the nozzle 3 is in opening position with the hole 11 aligned with the flow path 9.

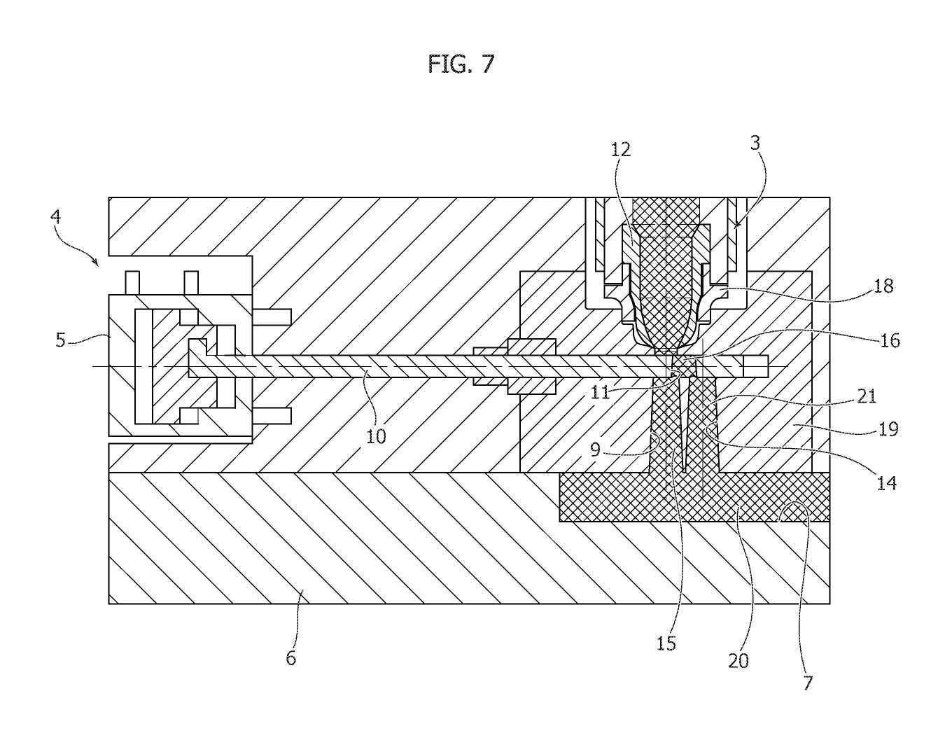

In FIG. 7 the obturator 4 is shown in an intermediate position in which the tip 12 of the nozzle 3 is placed in communication both with the flow path 9 and with the recess 14 through the hole 11.

FIG. 8 shows the obturator 4 in complete closing position in which the hole 11 communicates with the material of the moulded piece 20 through the recess 14.

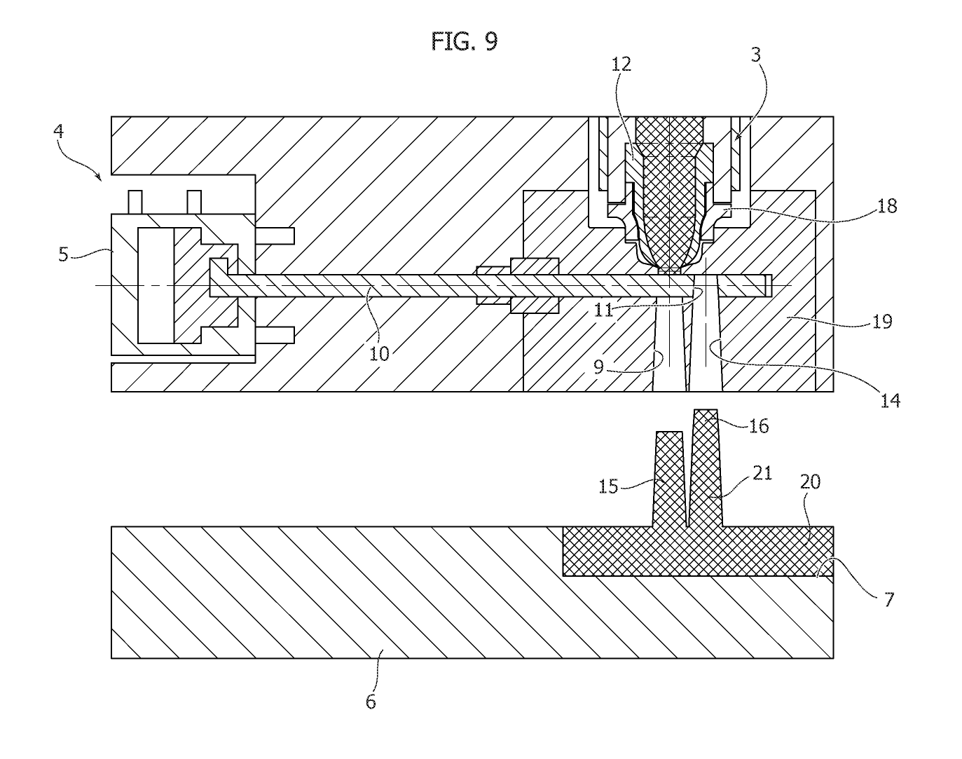

During cooling, the plastic material forms a third residual core 21 made of plastic material in the recess 14, which joins—on the one side—the second residual core 16 present in the through hole 11 and—on the other side—the material of the moulded piece 20. Likewise, the first residual core 15 is joined to the plastic material present in the hole 7 of the mould 6 so that, as visible in FIG. 9, the three residual cores 15, 16, 21 are removed simultaneously when removing the moulded piece from the mould 6.

The actuator means 5 of the lateral obturators 4 may be of the fluid type or, so as to further reduce the overall dimensions, they may conveniently be of the electric type with on/off coils, for example directly controlled by the pressing machine through the solenoid valves usually used for controlling fluid actuator.

In a further embodiment of the invention, the actuators may be rotary electric motors with speed and acceleration control, possibly simplified for example through potentiometers and without requiring a dedicated control unit, as illustrated in the patent application n° IT-102015000081904 on behalf of the Applicant (not published at the date of filing of the present application).

Obviously, the construction details and the embodiments of the invention may widely vary with respect to what has been described and illustrated by way of example. For example, though the first embodiment of the invention was described with reference to a ring nut 17 so-called “in mould”, i.e. extending up to the cavity 7 of the mould 6, and the second embodiment was described with a ring nut 18 so-called external, i.e. spaced from the cavity 7 of the mould 6 by an insert 19, a man skilled in the art will be able to opt for the best solution to be applied regardless of the pre-selected embodiment. In addition, the moulding apparatus may include a plurality of injectors for example controlled in a cascade or sequential fashion.

1. A method for injection moulding of plastic materials by using at least one nozzle for injecting fluid plastic material under pressure into a mould through a flow path communicating with a cavity of the mould, wherein supply of the fluid plastic material from the nozzle to said flow path is controlled by an obturator comprising a stem having a through hole and displaceable transversally with respect to the nozzle, between the latter and said flow path, between a closing position in which communication between the nozzle and flow path via said through hole is interrupted, and an opening position in which said through hole opens communication between the nozzle and the flow path; wherein the injected plastic material forms a first residual core within said flow path and a second residual core within said through hole of the obturator; and wherein, when the obturator is arranged in the closing position following injection, said through hole remains in communication with the cavity of the mould and the second residual core made of plastic material present in said through hole of the obturator remains joined to the first residual core made of plastic material and it is removed together with the first residual core.

2. The method according to claim 1, wherein said through hole communicates with said flow path also in the closing position of said obturator, thus the second residual core made of plastic material present in said through hole of the obturator is directly joined to the first residual core made of plastic material present in said flow path.

3. The method according to claim 1, wherein arranged adjacent to said flow path is a recess communicating with the cavity of the mould and with said through hole in the closing position of the obturator, and within which the injected plastic material forms a third residual core, thus the second residual core made of plastic material present in said through hole of the obturator is indirectly joined to the first residual core made of plastic material through said third residual core.

4. An apparatus for injection moulding of plastic materials comprising at least one nozzle for introducing fluid plastic material under pressure into a mould through a flow path communicating with a cavity of the mould, an obturator comprising a stem having a through hole and displaceable transversely with respect to the nozzle, between the latter and said flow path, between a closing position in which communication between the nozzle and the flow path via said through hole is interrupted, and an opening position in which said through hole opens the communication between the nozzle and the flow path, and an actuator arrangement to control displacement of the obturator between said closing and opening positions; wherein the injected plastic material forms a first residual core within said flow path and a second residual core within said through hole of the obturator; wherein in the closing position of the obturator following injection, said through hole remains in communication with the cavity of the mould, thus the second residual core made of plastic material present in said through hole of the obturator remains joined to the first residual core made of plastic material present in said flow path.

5. The apparatus according to claim 4, wherein said through hole communicates with said flow path also in the closing position of said obturator.

6. The apparatus according to claim 4, wherein said flow path has an inlet section having a width at least twice a width of said through hole.

7. The apparatus according to claim 5, wherein the nozzle has a terminal formed by a tip and a ring nut; and wherein said ring nut extends up to the cavity of the mould so as to form said flow path, and the stem of the obturator traverses the ring nut closely adjacent to said tip.

8. The apparatus according to claim 4, wherein arranged adjacent to said flow path is a recess communicating with the cavity of the mould and with said through hole in the closing position of the obturator.

9. The apparatus according to claim 8, wherein the nozzle has a terminal formed by a tip and a ring nut, wherein said ring nut is spaced from the cavity of the mould and an insert is provided between said terminal and the mould in which said flow path and said recess are formed; and wherein the stem of the obturator slidably extends in said insert.

10. The apparatus according to claim 4, wherein said actuator arrangement includes electric motors of the on/off coil type.

11. The apparatus according to claim 4, wherein said actuator arrangement is of a fluid type.
